(19) United States
(12) Patent Application Publication
(10) Pub. No.: US 2025/0134769 A1
(43) Pub. Date: May 1, 2025

(54) COOLING AND WARMING VIBRATOR FOR ADULT PRODUCTS

(71) Applicant: Dongguan Jiuqiang Electronic Technology Co., Ltd, Guangdong (CN)

(72) Inventor: Minggang Xiong, Jiangxi (CN)

(73) Assignee: Dongguan Jiuqiang Electronic Technology Co., Ltd, Guangdong (CN)

(21) Appl. No.: 18/411,039

(22) Filed: Jan. 12, 2024

(30) Foreign Application Priority Data
Nov. 1, 2023 (CN) 202322948480.1

(51) Int. Cl. A61H 39/04

(52) U.S. Cl. CPC A61H 39/04; A61H 2201/0221

(57) ABSTRACT

The present disclosure discloses a cooling and warming vibrator for adult products, which includes a cylindrical vibrator body. The vibrator body is provided with an upper cooling and warming component and a lower cooling and warming component. The upper end of the lower cooling and warming component is inserted into the upper cooling and warming component. A cold and hot insulation ring is provided between the upper cooling and warming component and the lower cooling and warming component. The upper end of the lower cooling and warming component is provided with a cooling piece and a warming piece. The cooling piece and the warming piece are in contact with the inner wall of the upper cooling and warming component. A vibration motor is provided in the lower cooling and warming component.

### CROSS-REFERENCE TO RELATED APPLICATION

This application claims the priority benefit of China application serial no. 202322948480.1, filed on Nov. 1, 2023. The entirety of the above-mentioned patent application is hereby incorporated by reference herein and made a part of this specification.

### BACKGROUND

### Technical Field

The present disclosure relates to the technical field of adult products, and in particular to a cooling and warming vibrator for adult products.

### Background Art

At present, some adults choose to use vibrators among adult products. However, existing vibrators generally only have a vibration function and do not have warming or cooling functions. Therefore, it is necessary to design a cooling and warming vibrator for adult products.

### SUMMARY

The purpose of the present disclosure is to provide a cooling and warming vibrator for adult products in view of the deficiencies of the prior art. The cooling and warming vibrator for adult products has a novel design, a simple structure, and a fast and good cooling and warming effect.

To achieve the above purpose, the present disclosure is implemented by the following technical solution.

A cooling and warming vibrator for adult products comprises a cylindrical vibrator body, wherein the vibrator body is provided with an upper cooling and warming component and a lower cooling and warming component, the upper end of the lower cooling and warming component is inserted into the upper cooling and warming component, a cold and hot insulation ring is provided between the upper cooling and warming component and the lower cooling and warming component, the upper end of the lower cooling and warming component is provided with a cooling piece and a warming piece, the cooling piece and the warming piece are in contact with the inner wall of the upper cooling and warming component, and a vibration motor is provided in the lower cooling and warming component.

The material of the upper cooling and warming component is aluminum alloy.

The material of the lower cooling and warming component is aluminum alloy.

The material of the cold and hot insulation ring is plastic.

The beneficial effects of the present disclosure are as follows: a cooling and warming vibrator for adult products described in the present disclosure comprises a cylindrical vibrator body, wherein the vibrator body is provided with an upper cooling and warming component and a lower cooling and warming component, the upper end of the lower cooling and warming component is inserted into the upper cooling and warming component, a cold and hot insulation ring is provided between the upper cooling and warming component and the lower cooling and warming component, the upper end of the lower cooling and warming component is provided with a cooling piece and a warming piece, the cooling piece and the warming piece are in contact with the inner wall of the upper cooling and warming component, and a vibration motor is provided in the lower cooling and warming component. In the present disclosure, by providing the cold and hot insulation ring between the upper cooling and warming component and the lower cooling and warming component, the upper cooling and warming component are separated from the lower cooling and warming component to prevent cold and heat conduction between them; and by providing the cooling piece and the warming piece on the upper end of the lower cooling and warming component with the cooling piece and the warming piece being in contact with the inner wall of the upper cooling and warming component, the upper cooling and warming component and the lower cooling and warming component can achieve cooling or warming as needed with a fast and good cooling and warming effect. Therefore, the present disclosure has the advantages of novel design, simple structure, and fast and good cooling and warming effect.

### BRIEF DESCRIPTION OF THE DRAWINGS

The present disclosure will be further illustrated below in conjunction with the accompanying drawings, but embodiments in the accompanying drawings do not constitute any limitation on the present disclosure.

FIG. 1 is a schematic structural diagram of a vibrator according to the present disclosure; and

FIG. 2 is a schematic diagram of an exploded structure of a vibrator according to the present disclosure.

### DETAILED DESCRIPTION OF THE EMBODIMENTS

The present disclosure will be illustrated below in conjunction with specific embodiments.

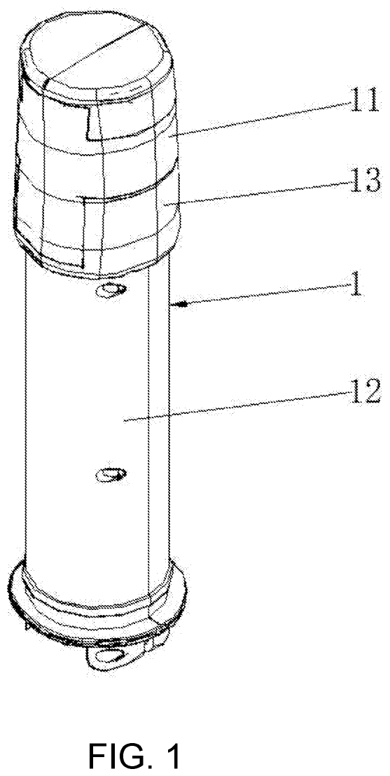

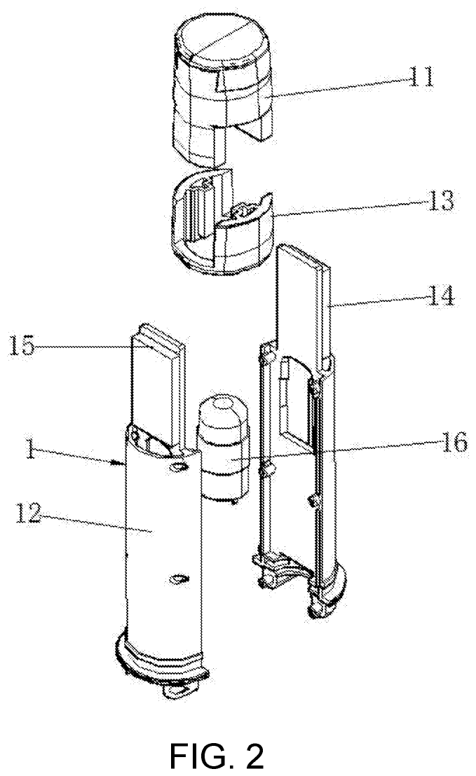

As shown in FIGS. 1-2, a cooling and warming vibrator for adult products includes a cylindrical vibrator body 1. The vibrator body 1 is provided with an upper cooling and warming component 11 and a lower cooling and warming component 12. The upper end of the lower cooling and warming component 12 is inserted into the upper cooling and warming component 11. A cold and hot insulation ring 13 is provided between the upper cooling and warming component 11 and the lower cooling and warming component 12. The upper end of the lower cooling and warming component 12 is provided with a cooling piece 14 and a warming piece 15. The cooling piece 14 and the warming piece 15 are in contact with the inner wall of the upper cooling and warming component 11. A vibration motor 16 is provided in the lower cooling and warming component 12.

Preferably, in this embodiment, the material of the upper cooling and warming component 11 is aluminum alloy, which has fast heat conduction and heat dissipation.

Preferably, in this embodiment, the material of the lower cooling and warming component 12 is aluminum alloy, which has fast heat conduction and heat dissipation.

Preferably, in this embodiment, the material of the cold and hot insulation ring 13 is plastic, which has a good cold and hot insulation effect.

To make a further explanation, in the present disclosure, by providing the cold and hot insulation ring 13 between the upper cooling and warming component 11 and the lower cooling and warming component 12, the upper cooling and warming component 11 are separated from the lower cooling and warming component 12 to prevent cold and heat conduction between them; and by providing the cooling piece 14 and the warming piece 15 on the upper end of the lower cooling and warming component 12 with the cooling piece 14 and the warming piece 15 being in contact with the inner wall of the upper cooling and warming component 11, the upper cooling and warming component 11 and the lower cooling and warming component 12 can achieve cooling or warming as needed with a fast and good cooling and warming effect. Therefore, the present disclosure has the advantages of novel design, simple structure, and fast and good cooling and warming effect.

The above contents are merely preferred embodiments of the present disclosure, for a person of ordinary skill in the art, there are changes in both of the specific implementations and the application range according to the idea of the present disclosure. The contents of the description should not be construed as limitations on the present disclosure.

What is claimed is:

1. A cooling and warming vibrator for adult products, comprising a cylindrical vibrator body, wherein the vibrator body is provided with an upper cooling and warming component and a lower cooling and warming component, an upper end of the lower cooling and warming component is inserted into the upper cooling and warming component, a cold and hot insulation ring is provided between the upper cooling and warming component and the lower cooling and warming component, the upper end of the lower cooling and warming component is provided with a cooling piece and a warming piece, the cooling piece and the warming piece are in contact with an inner wall of the upper cooling and warming component, and a vibration motor is provided in the lower cooling and warming component.

2. The cooling and warming vibrator for adult products according to claim 1, wherein a material of the upper cooling and warming component is aluminum alloy.

3. The cooling and warming vibrator for adult products according to claim 1, wherein a material of the lower cooling and warming component is aluminum alloy.

4. The cooling and warming vibrator for adult products according to claim 1, wherein a material of the cold and hot insulation ring is plastic.
